(19) United States
(12) Patent Application Publication
(10) Pub. No.: US 2025/0230786 A1
(43) Pub. Date: Jul. 17, 2025

(54) PROPULSION DEVICE, WATERCRAFT PROPULSION UNIT, AND WATERCRAFT WITH WATERCRAFT PROPULSION UNIT

(71) Applicant: YAMAHA HATSUDOKI KABUSHIKI KAISHA, Iwata-shi (JP)

(72) Inventor: Yutaka NAKANISHI, Shizuoka (JP)

(21) Appl. No.: 19/014,647

(22) Filed: Jan. 9, 2025

(30) Foreign Application Priority Data
Jan. 17, 2024 (JP) 2024-005708

(51) Int. Cl. F02M 35/12; B63H 21/14; F02M 35/16

(52) U.S. Cl. CPC F02M 35/1255; B63H 21/14; F02M 35/165

(57) ABSTRACT

A watercraft propulsion unit includes an engine body, a throttle body, an intake passage, and a resonator. The throttle body is configured to supply air to the engine body. The intake passage is connected to the throttle body on an upstream side of the throttle body. The intake passage includes an intake inlet to draw in the air and an intake outlet to guide the air to the throttle body. The resonator is connected to the intake passage to reduce an intake sound of the air. A volume of an internal space of the resonator is greater than a volume of an internal space of the intake passage between the intake inlet and the intake outlet.

### CROSS REFERENCE TO RELATED APPLICATIONS

This application claims the benefit of priority to Japanese Patent Application No. 2024-005708 filed on Jan. 17, 2024. The entire contents of this application are hereby incorporated herein by reference.

### BACKGROUND OF THE INVENTION

### 1. Field of the Invention

The present invention relates to propulsion devices, watercraft propulsion units, and watercraft with watercraft propulsion units.

### 2. Description of the Related Art

JP Patent No. 6123616 discloses a watercraft propulsion unit as an example of a propulsion device. The watercraft propulsion unit includes an intake structure and a resonator. The intake structure has an intake duct, an air cleaner box, and a throttle body. The air cleaner box is connected to an outlet of the intake duct. The air cleaner box is disposed between the outlet of the intake duct and an inlet of the throttle body. The throttle body is disposed at a lower portion of the air cleaner box.

The resonator is disposed along the intake duct at the lower portion of the intake duct. In addition, the resonator is disposed between the intake duct and an intake manifold to insulate an engine heat. The intake manifold is connected to the throttle body and is disposed below the resonator along the intake duct.

In a conventional watercraft propulsion unit, the intake structure includes the intake duct as an intake passage, the air cleaner box, and the throttle body. In the intake structure, there is a problem that the intake structure becomes large since the air cleaner box is disposed between the intake duct and the throttle body.

Furthermore, in a conventional watercraft propulsion unit, the resonator is disposed in a limited space between the intake duct which serves as the intake passage and the intake manifold. In this case, it is difficult to provide sufficient volume of an internal space of the resonator, and the volume of the internal space of the resonator becomes smaller than the volume of an internal space of the intake duct. For this reason, it is necessary to reduce the intake noise by installing an intake silencer box which is the air cleaner box in addition to the resonator installed in the intake duct. As a result, this causes a problem that the size of the intake structure becomes larger. On the other hand, if the volume of the internal space of the resonator is increased, it is necessary to provide a large amount of the above-mentioned space. As a result, this causes a problem that the size of the watercraft propulsion unit becomes larger.

Furthermore, as a method for solving the problems of the conventional technology, a direct intake system, which does not include the air cleaner box, is sometimes used to provide the large volume of the internal space of the resonator. In this case, a space is provided around the intake structure. However, the intake structure of an upstream side of the throttle body becomes complicated because it is necessary to provide a structure to prevent dust and mist from entering during air intake. As a result, this causes a problem that the size of the watercraft propulsion unit becomes larger.

### SUMMARY OF THE INVENTION

Example embodiments of the present invention provide propulsion devices that reduce a size of an intake structure and reduce or prevent intake noise.

A propulsion device according to an example embodiment of the present invention includes an engine body, a throttle body, an intake passage and a resonator. The throttle body is configured to supply air to the engine body. The intake passage is connected to the throttle body on an upstream side of the throttle body. The intake passage includes an intake inlet to draw in the air and an intake outlet to guide the air to the throttle body. The resonator is connected to the intake passage to reduce an intake sound of the air. A volume of an internal space of the resonator is greater than a volume of an internal space of the intake passage between the intake inlet and the intake outlet.

In the present propulsion device, the intake structure includes the intake passage and the throttle body. Since the intake passage is directly connected to the throttle body, it is possible to reduce the size of the intake structure in comparison with the prior art. In addition, in the present propulsion device, since the volume of the internal space of the resonator is greater than the volume of the internal space of the intake passage, it is possible to reduce or prevent the intake noise. In other words, in the present propulsion device, it is possible to reduce the size of the intake structure and reduce or prevent the intake noise.

The propulsion device may be configured as follows. The internal space of the resonator is a closed space and is integral with the internal space of the intake passage. In this case, even if the volume of the internal space of the resonator is greater than the volume of the internal space of the intake passage, it is possible to reduce the size of the intake structure.

The propulsion device may also be configured as follows. The resonator may be separate from the intake passage and mounted to the intake passage. In this case, the resonator can be easily mounted and detached from the intake passage.

The propulsion device may also be configured as follows. The intake passage may be between the throttle body and at least a portion of the resonator. In this case, the internal space of the resonator is easily increased so that the volume of the internal space of the resonator is greater than the volume of the internal space of the intake passage.

The propulsion device may also be configured as follows. At least a portion of the intake passage may be above the throttle body. The intake passage is between the throttle body and a portion of the resonator in a vertical direction. In this case, even if the internal space of the resonator is such that the volume of the internal space of the resonator is greater than the volume of the internal space of the intake passage, it is possible to reduce the size of the intake structure.

The propulsion device may also be configured as follows. At least a portion of the intake passage may be above the throttle body. At least a portion of the resonator is located on a side portion of the intake passage so that at least a portion of the internal space of the resonator overlaps with the internal space of the intake passage in a view in a state where the propulsion device is viewed in at least one of a left-right direction of the propulsion device or a front-rear direction of the propulsion device.

In this case, the internal space of the resonator is easily increased so that the volume of the internal space of the resonator is greater than the volume of the internal space of the intake passage. In addition, even if the internal space of the resonator is such that the volume of the internal space of the resonator is greater than the volume of the internal space of the intake passage, it is possible to reduce the size of the intake structure.

The propulsion device may also be configured as follows. At least a portion of the intake passage may be above the throttle body. At least a portion of the resonator is provided on an upper portion of the intake passage so that at least a portion of the internal space of the resonator overlaps with the internal space of the intake passage in a state where the propulsion device is viewed from above to below.

In this case, the internal space of the resonator is easily increased so that the volume of the internal space of the resonator is greater than the volume of the internal space of the intake passage. In addition, even if the internal space of the resonator is such that the volume of the internal space of the resonator is greater than the volume of the internal space of the intake passage, it is possible to reduce the size of the intake structure.

The propulsion device may also be configured as follows. The intake passage may include a first passage including the intake inlet and a second passage including the intake outlet. A first straight line extending through a center of the intake inlet and along the first passage and a second straight line extending through a center of the intake outlet and along the second passage intersect with each other.

In this case, the air is drawn from the intake inlet of the first passage and moves in the first passage along the first straight line. The air then moves in the second passage along the second straight line and is discharged through the intake outlet of the second passage. Thus, it is possible to reduce the size of the intake passage.

The propulsion device may also be configured as follows. The intake passage may include a connecting hole to connect the internal space of the intake passage and the internal space of the resonator to each other. At least a portion of the connecting hole is connected to the internal space of the intake passage in the first passage. In this case, the intake noise of the air passing in the first passage can be suitably reduced or prevented by the resonator.

The propulsion device may also be configured as follows. The first passage may include a connection on an opposite side to the intake inlet and connected to the second passage. At least a portion of the connecting hole is connected to the internal space of the intake passage at the connection. In this case, the intake noise of the air passing in the connection of the first passage can be suitably reduced or prevented by the resonator.

The propulsion device may also be configured as follows. The first passage may include a connection on an opposite side to the intake inlet and connected to the second passage. The resonator is connected to the intake passage so that the internal space of the resonator covers at least a portion of the connection. In this case, it is possible to reduce the size of the resonator.

The propulsion device may also be configured as follows. A first maximum length that is defined as a maximum length between inner surfaces of the resonator which face each other in a direction in which the first passage extends may be greater than a second maximum length that is a maximum length from the intake inlet to an inner surface of the connection in the direction. In this case, it is possible to reduce the size of the resonator and reduce or prevent the intake noise.

A watercraft propulsion unit according to an example embodiment of the present invention includes an engine body, a throttle body, an intake passage, and a resonator. The throttle body is configured to supply air to the engine body. The intake passage is connected to the throttle body on an upstream side of the throttle body. The intake passage includes an intake inlet to draw in the air and an intake outlet to guide the air to the throttle body. The resonator is connected to the intake passage to reduce an intake sound of the air. A volume of an internal space of the resonator is greater than a volume of an internal space of the intake passage between the intake inlet and the intake outlet.

In the present watercraft propulsion unit, the intake structure includes the intake passage and the throttle body. Since the intake passage is directly connected to the throttle body, it is possible to reduce the size of the intake structure. In addition, in the present propulsion device, since the volume of the internal space of the resonator is greater than the volume of the internal space of the intake passage, it is possible to reduce or prevent the intake noise. In other words, in the present propulsion device, it is possible to reduce the size of the intake structure and reduce or prevent the intake noise.

A watercraft according to an example embodiment of the present invention includes a watercraft body and the above described watercraft propulsion unit. The watercraft propulsion unit is mounted to a rear portion of the watercraft body. In the present watercraft, it is possible to reduce a size of the intake structure and reduce or prevent the intake noise of the watercraft propulsion unit.

According to example embodiments of the present invention, it is possible to provide propulsion devices, watercraft propulsion units, and watercraft that reduce the size of the intake structure and reduce or prevent the intake noise.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view which shows a schematic configuration of a watercraft.

FIG. 2 is a side view which shows a schematic configuration of a watercraft propulsion device.

FIG. 3 is an external perspective view of a cowl assembly.

FIG. 4 is an external perspective view of an engine assembly.

FIG. 5 is an external perspective view of a silencer.

FIG. 6 is a cross-sectional view of the silencer taken along line VI in FIG. 5.

FIG. 7 is a cross-sectional view of the silencer in a state where the silencer is cut by a line VII in FIG. 6.

FIG. 8 is a top view of the silencer in a state where a cover portion is rid of a housing of the silencer.

### DETAILED DESCRIPTION OF THE EXAMPLE EMBODIMENTS

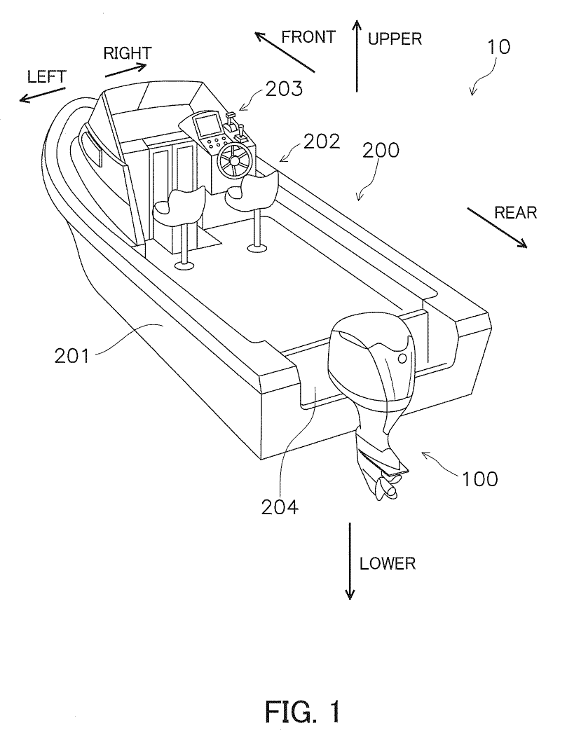

Configurations of a watercraft according to example embodiments of the present invention will be described below with reference to the drawings. FIG. 1 is an external perspective view which shows a schematic configuration of the watercraft 10 according to an example embodiment. FIG. 1 shows arrows representing various directions. Directions shown in the other drawings described below correspond to the directions of FIG. 1.

Specifically, the arrows corresponding to forward, rearward, left, right, upper and lower directions are shown in each figure. A front-rear direction, a left-right direction and an up-down direction (a vertical direction) are directions perpendicular to each other.

The watercraft 10 includes a hull 200 and a watercraft propulsion unit 100 (an example of a propulsion device). The hull 200 includes a main body 201, a cockpit 202, a operating device 203, and a transom 204. The main body 201 is where an user and/or users rides. The cockpit 202 is provided on the main body 201. The operating device 203 maneuvers the watercraft. The operating device 203 is provided on the main body 201 near the cockpit 202. The transom 204 is provided on a rear portion of the hull 200. The transom 204 may be interpreted as being included in the main body 201.

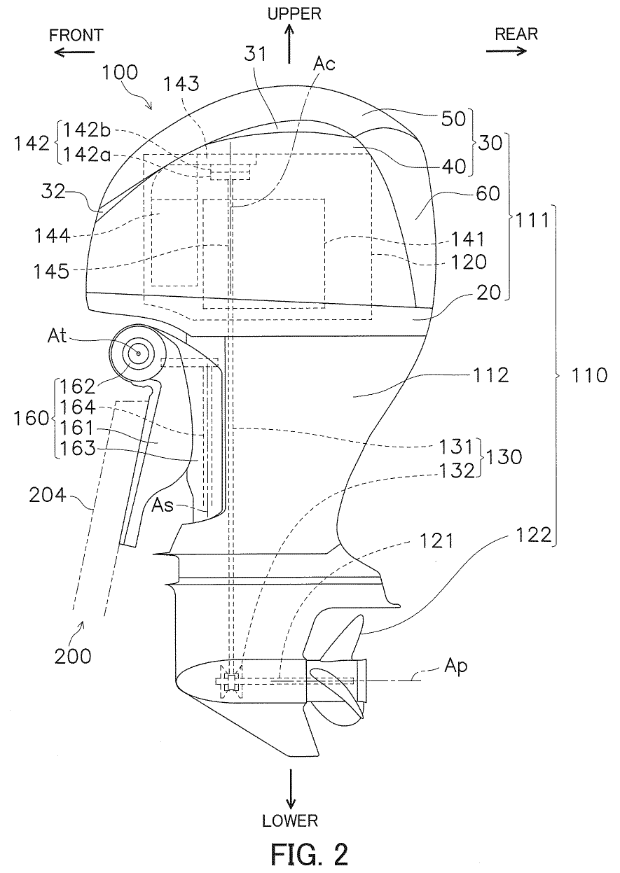

FIG. 2 is a side view which shows a schematic configuration of the watercraft propulsion unit 100. Unless otherwise specified, the following description will be providing assuming that the attitude of the watercraft propulsion unit 100 of FIG. 2 is in a reference attitude. When the watercraft propulsion unit 100 is in the reference attitude, the front-rear direction of the watercraft propulsion unit 100 corresponds to a longitudinal direction of the hull 200 shown in FIG. 1. The left-right direction of the watercraft propulsion unit 100 corresponds to a direction perpendicular to the longitudinal direction of the hull 200 in FIG. 1. The up-down direction of the watercraft propulsion unit 100 is a direction perpendicular to the front-rear direction of the watercraft propulsion unit 100 and the left-right direction of the watercraft propulsion unit 100.

In the reference attitude, a rotation axis Ac of a crankshaft 145 (described later) extends in the up-down direction, and a rotation axis Ap of a propeller shaft 121 (described later) extends in the front-rear direction. When the attitude of the watercraft propulsion unit 100 is the reference attitude, each direction of the watercraft propulsion unit 100 coincides with each of the directions described above.

The watercraft propulsion unit 100 shown in FIGS. 1 and 2 generates thrust to propel the watercraft 10. As shown in FIG. 1, the watercraft propulsion unit 100 is mounted to the rear portion of the hull 200. In particular, the watercraft propulsion unit 100 is mounted to the transom 204 of the hull 200. In the present example embodiment, an example is shown in which the watercraft 10 includes one watercraft propulsion unit 100, but the watercraft 10 can include a plurality of watercraft propulsion units 100. As shown in FIG. 2, the watercraft propulsion unit 100 includes a propulsion unit body 110 and a suspension device 160.

As shown in FIG. 2, the propulsion unit body 110 includes a cowl assembly 111, a casing 112, an engine assembly 120, a propeller shaft 121, a propeller 122, and a transmission mechanism 130. The cowl assembly 111 defines an upper portion of the propulsion unit body 110. The cowl assembly 111 houses the engine assembly 120 and an upper portion of the transmission mechanism 130.

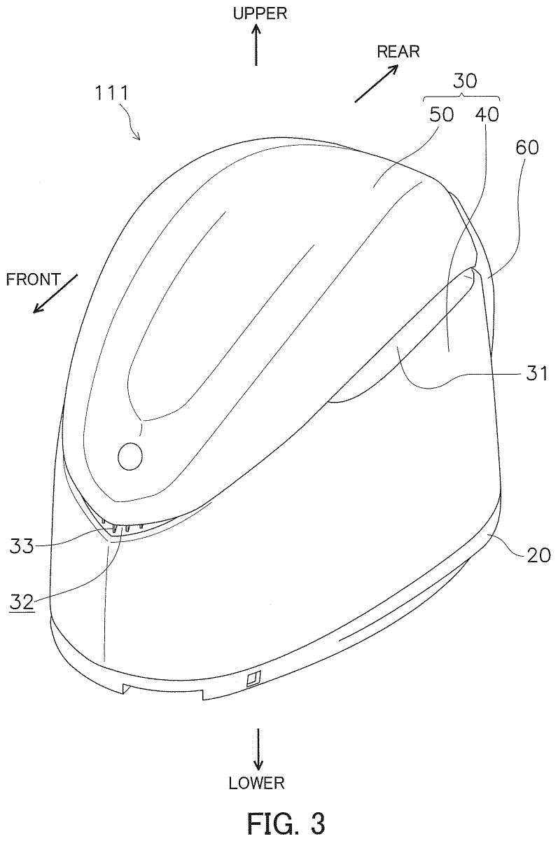

FIG. 3 is an external perspective view of the cowl assembly 111. As shown in FIGS. 2 and 3, the cowl assembly 111 include a bottom cowl 20, a top cowl assembly 30, and a rear panel 60. The bottom cowl 20 defines the lower portion of the cowl assembly 111. The top cowl assembly 30 defines the upper portion of the cowl assembly 111. The top cowl assembly 30 is provided on top of the bottom cowl 20.

A cowl air intake port 31 and a heat discharge port 32 are provided on the top cowl assembly 30. The cowl air intake port 31 takes outside air into the cowl assembly 111. The outside air, which is taken from the cowl air intake port 31, is supplied to the engine assembly 120. The heat discharge port 32 is an opening which exhausts heat from an inside of the cowl assembly 111. A louver 71 is provided on the heat discharge port 32.

As shown in FIGS. 2 and 3, the top cowl assembly 30 includes a top cowl body 40 and a cover 50. The top cowl body 40 defines a lower portion of the top cowl assembly 30. The cover 50 covers at least a portion of the top cowl body 40 from the outside of the top cowl body 40. In this example embodiment, the cover 50 covers an upper portion of the top cowl body 40.

The cowl air intake port 31 and the heat discharge port 32 described above are provided between the top cowl body 40 and the cover 50. The rear panel 60 defines a rear portion of the cowl assembly 111. The top cowl assembly 30 and the rear panel 60 are detachably mounted to the bottom cowl 20.

As shown in FIG. 2, the casing 112 defines a lower portion of the propulsion unit body 110. The casing 112 is disposed below the cowl assembly 111. The cowl assembly 111 houses a lower portion of the transmission mechanism 130, the propeller shaft 121 and the propeller 122.

As shown in FIG. 2, the engine assembly 120 is disposed inside the top cowl body 40. The engine assembly 120 includes an engine body 141, a flywheel-type magneto generator 142, a heat discharge system component 143, and an intake system component 144.

The engine body 141 is a prime mover which generates power. The engine body 141 includes, for example, an internal combustion engine. The engine body 141 includes a crankshaft 145. The crankshaft 145 converts reciprocating motion of a piston of the engine body 141 (not shown) into rotational motion. The crankshaft 145 includes a rotation axis Ac. The rotation axis Ac of the crankshaft 145 extends in the up-down direction.

As shown in FIG. 2, the flywheel-type magneto generator 142 is an AC generator used as an auxiliary machine for the engine body 141. The flywheel-type magneto generator 142 is disposed above the engine body 141. The flywheel-type magneto generator 142 includes a flywheel rotor 142a and a stator coil 142b.

The flywheel rotor 142a is connected to an upper end portion of the crankshaft 145. The flywheel rotor 142a rotates in response to the rotation of the crankshaft 145. The stator coil 142b faces the flywheel rotor 142a. As the flywheel rotor 142a rotates, the north and south poles of the magnet of the flywheel rotor 142a alternately pass through the stator coil 142b. During this operation, a current is generated by the stator coil 142b by electromagnetic induction.

As shown in FIG. 2, the heat discharge system component 143 exhausts heat near the engine body 141. The intake system component 144 takes in air into the engine body 141. Specifically, the cowl air intake port 31 and an opening of an intake inlet 152a (described below) of the intake system component 144 are spaced apart from each other. The cowl air intake port 31 and an air intake port of the engine body 141 are oriented in different directions and do not overlap with each other. In this state, the air, which is taken from the cowl air intake port 31, passes through an inside of the top cowl assembly 30 and is supplied from an intake passage 152 (described below) of the intake system component 144 to the engine body 141. The heat discharge system component 143 and the intake system component 144 will be described in detail below.

As shown in FIG. 2, the propeller shaft 121 is disposed at a lower portion of the propulsion unit body 110. The propeller shaft 121 extends in the front-rear direction. A front end of the propeller shaft 121 is housed in the casing 112. A rear end of the propeller shaft 121 protrudes rearward from the casing 112. The propeller shaft 121 includes a rotation axis Ap. The rotation axis Ap extends in the front-rear direction. The propeller shaft 121 rotates around a rotation axis Ap.

As shown in FIG. 2, the propeller 122 is a rotating body which includes a plurality of blades. The propeller 122 is mounted to a rear end of the propeller shaft 121. The propeller 122 rotates around the rotation axis Ap of the propeller shaft 121 in response to rotation of the propeller shaft 121. The rotation of the propeller 122 generates thrust.

As shown in FIG. 2, the transmission mechanism 130 transmits the power of the engine body 141 to the propeller shaft 121. At least a portion of the transmission mechanism 130 is housed in the casing 112. The transmission mechanism 130 includes a drive shaft 131 and a shift mechanism 132.

The drive shaft 131 is disposed below the crankshaft 145 of the engine body 141. The drive shaft 131 extends in the up-down direction. An upper end of the drive shaft 131 is connected to the crankshaft 145. The drive shaft 131 rotates in response to rotation of the crankshaft 145.

As shown in FIG. 2, the shift mechanism 132 is connected to a lower end of the drive shaft 131 and a front end of the propeller shaft 121. The shift mechanism 132 includes, for example, a plurality of gears and a clutch (not shown) which switches an engaging state of the gears. The shift mechanism 132 switches rotation direction of the drive shaft 131 and transmits rotation of the drive shaft 131 to the propeller shaft 121.

When the shift mechanism 132 transmits the rotation of the drive shaft 131 to the propeller shaft 121 as rotation in a forward direction, the propeller shaft 121 and the propeller 122 rotate in the forward direction. In this case, the propeller 122 generates thrust in the forward direction. On the other hand, when the shift mechanism 132 transmits the rotation of the drive shaft 131 to the propeller shaft 121 as rotation in a reverse direction, the propeller shaft 121 and the propeller 122 rotate in the reverse direction. In this case, the propeller 122 generates thrust in the reverse direction.

As shown in FIG. 2, the suspension device 160 suspends the propulsion unit body 110 from the hull 200. The suspension device 160 is provided on the propulsion unit body 110. Specifically, the suspension device 160 is provided on the propulsion unit body 110, for example, on a front portion of the casing 112.

The suspension device 160 includes a pair of clamp brackets 161, a tilt shaft 162, a swivel bracket 163, and a steering shaft 164. The pair of clamp brackets 161 are spaced apart from each other in the left-right direction. The pair of clamp brackets 161 are fixed to the transom 204 of the hull 200 by, for example, bolts. The tilt shaft 162 is supported by the pair of clamp brackets 161. A tilt axis At, which is a center line of the tilt shaft 162, extends in a horizontal direction (the left-right direction).

The swivel bracket 163 is disposed at a front portion of the casing 112. The swivel bracket 163 is disposed between the pair of clamp brackets 161. The swivel bracket 163 is supported by the tilt shaft 162. The swivel bracket 163 rotates about the tilt axis At of the tilt shaft 162 by a tilt device (not shown) including an actuator such as a hydraulic cylinder. A tilt angle of the watercraft propulsion unit 100 is set by this rotation.

Specifically, the tilt angle of the propulsion unit body 110 is set in a range from a tilt down state (a state in which the watercraft propulsion unit 100 is in a reference attitude) in which the propeller 122 is disposed under a water surface to a tilt up state in which the propeller 122 is disposed above the water surface. A trim operation can also be performed to adjust the attitude of the watercraft 10 during traveling by adjusting the angle of the propulsion unit body 110 about the tilt axis At.

As shown in FIG. 2, the steering shaft 164 is fixed to the propulsion unit body 110. The steering shaft 164 is rotatably supported by the swivel bracket 163. A steering axis As, which is a center line of the steering shaft 164, extends in the up-down direction. The steering shaft 164 is rotated about a steering axis As by an operating device (not shown) including an actuator such as a hydraulic cylinder. A steering angle of the watercraft propulsion unit 100 is set by this rotation. Specifically, the thrust direction of the propeller 122 is set based on the orientation of the hull 200.

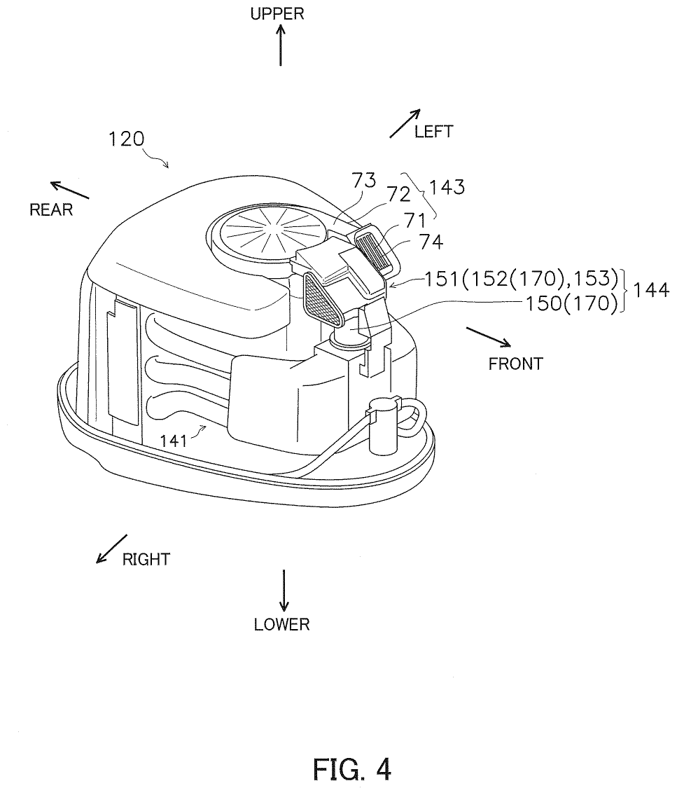

FIG. 4 is an external perspective view of the engine assembly 120 of the propulsion unit body 110 in the watercraft propulsion unit 100. The engine assembly 120 includes the engine body 141, the heat discharge system component 143 and the intake system component 144.

As shown in FIG. 4, the heat discharge system component 143 includes a fan (not shown), the louver 71, and a shroud cover 72. The fan is covered by the shroud cover 72. The louver 71 defines an outlet port 74 which exhausts the heat. The shroud cover 72 defines a heat discharge flow path 73 which is connected to the outlet port 74. The heat, which is generated by operating the engine body 141, is sent from the engine body 141 to the heat discharge flow path 73 by operating the fan. The heat of the heat discharge flow path 73 is discharged from the heat discharge flow path 73 to the outside of the engine assembly 120 via the outlet port 74.

As shown in FIG. 4, the intake system component 144 includes a throttle body 150 and a silencer 151. The throttle body 150 supplies the air to the engine body 141. Specifically, the throttle body 150 controls the amount of air which is supplied to the engine body 141. The throttle body 150 is connected to the silencer 151. The air, which is taken into the intake passage 152 of the silencer 151, flows into an air flow passage (not shown) in the throttle body 150 and then is supplied to the engine body 141.

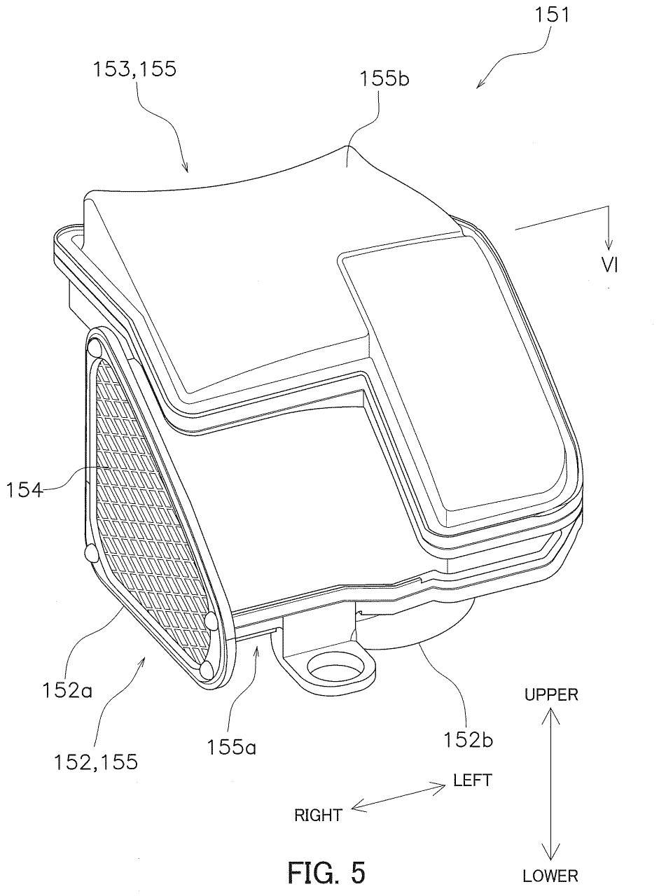

As shown in FIG. 4, the silencer 151 is mounted to the engine body 141. FIG. 5 is an external perspective view of the silencer 151. As shown in FIG. 5, the silencer 151 includes the intake passage 152 and a resonator 153. Each structure of the silencer 151 is defined by a housing 155 which includes a housing body 155a and a cover portion 155b. An intake structure 170 includes the throttle body 150 shown in FIG. 4 and the intake passage 152 of the silencer 151.

As shown in FIG. 5, the intake passage 152 is provided on or connected to the silencer 151. As shown in FIG. 4, the intake passage 152 is connected to the throttle body 150 on the upstream side of the throttle body 150. In the following, a front portion of the intake passage 152, a rear portion of the intake passage 152 and a side portion of the intake passage 152 are defined as follows. The front portion of the intake passage 152 refers to a portion in front of a center position of the intake passage 152 in the front-rear direction of the intake passage 152 (the intake system component 144) in a top view in a state where the propulsion unit body 110 is viewed from above to below or in a side view in a state where the propulsion unit body 110 is viewed from the left or the right.

The rear portion of the intake passage 152 refers to a portion behind a center position of the intake passage 152 in the front-rear direction of the intake passage 152 (the intake system component 144) in the top view of the propulsion unit body 110 or in the side view of the propulsion unit body 110. The side portion of the intake passage 152 refers to a portion behind a front-end position of the intake passage 152 (intake system component 144) in the front-rear direction and in front of a rear-end position of the intake passage 152 (intake system component 144) in the front-rear direction in the side view of the propulsion unit body 110.

The top view of the propulsion unit body 110 and the side view of the propulsion unit body 110 respectively correspond to a top view in a state where the engine assembly 120 is viewed from above to below and a side view in a state where the engine assembly 120 is viewed from the left or the right.

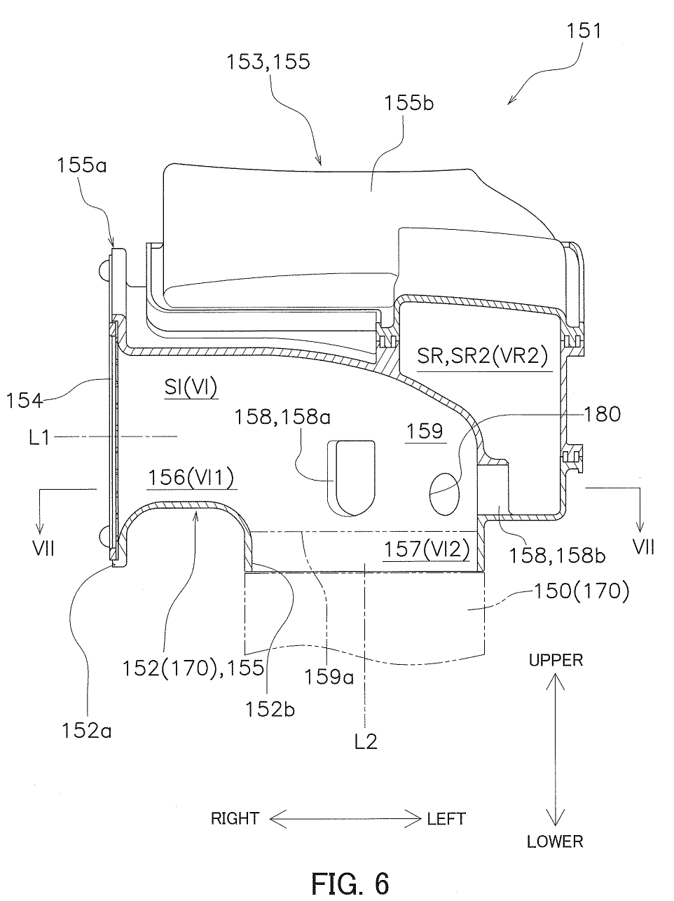

FIG. 6 is a cross-sectional view of the silencer 151 taken along line VI in FIG. 5. As shown in FIGS. 5 and 6, the intake passage 152 includes the intake inlet 152a and the intake outlet 152b. The intake passage 152 guides the air, which is drawn from the intake inlet 152a, toward the intake outlet 152b.

As shown in FIGS. 5 and 6, the intake inlet 152a is provided on the silencer 151. The intake inlet 152a is an opening through which the air is drawn in, and defines one end of the intake passage 152. An air intake cover 154 is mounted to the intake inlet 152a. In this example embodiment, the intake inlet 152a opens on a right side on the engine assembly 120. The intake inlet 152a may open in another direction as long as it is in a different direction from the intake outlet 152b. No other components of the engine assembly 120 are substantially present in the direction in which the intake inlet 152a opens, for example, on the right side of the intake inlet 152a.

As shown in FIGS. 5 and 6, the intake outlet 152b is provided on the silencer 151. The intake outlet 152b is an opening which guides the air to the throttle body 150 and defines the other end of the intake passage 152. In this example embodiment, the intake outlet 152b opens downward on the engine assembly 120. The intake outlet 152b may open in another direction as long as it is in a different direction from the intake inlet 152a. The intake outlet 152b is connected to the throttle body 150.

As shown in FIG. 6, the intake passage 152 is disposed between the throttle body 150 and at least a portion of the resonator 153. Specifically, at least a portion of the intake passage 152 is disposed above the throttle body 150. The intake passage 152 is disposed between the throttle body 150 and a portion of the resonator 153 in the up-down direction.

The intake passage 152 includes a first passage 156 including the intake inlet 152a, a second passage 157 including an intake outlet 152b and at least one connecting hole 158. In this example embodiment, the first passage 156 extends in the left-right direction. The intake inlet 152a is provided at the right end of the first passage 156. A first straight line L1 is defined in the first passage 156. The first straight line L1 passes through the center of the intake inlet 152a and extends in the left-right direction along the first passage 156. The first passage 156 includes a connection 159. The connection 159 is connected to the second passage 157 on the first passage 156. The connection 159 is provided on the opposite side to the intake inlet 152a.

In this example embodiment, the second passage 157 extends in the up-down direction. The second passage 157 is integral with the first passage 156. An upper portion of the second passage 157 is connected to the connection 159 of the first passage 156. The intake outlet 152b is provided at the lower end of the second passage 157. A second straight line L2 is defined in the second passage 157. The second straight line L2 passes through the center of the intake outlet 152b and extends in the up-down direction along the second passage 157. The second straight line L2 intersects with the first straight line L1.

As shown in FIG. 6, in a front view in a state where the propulsion unit body 110 is viewed from the front, the first passage 156 and the second passage 157 are oriented so that the first straight line L1 and the second straight line L2 intersect with each other. The connection 159 is located at a portion of the first passage 156 where the first straight line L1 and the second straight line L2 intersect with each other.

At least one connecting hole 158 connects an internal space SI of the intake passage 152 and an internal space SR of the resonator 153 to each other. An internal space of at least one connecting hole 158 may be considered as a space included in the internal space SI of the intake passage 152. An internal space of at least one connecting hole 158 may be considered as a space included in the internal space SR of the resonator 153.

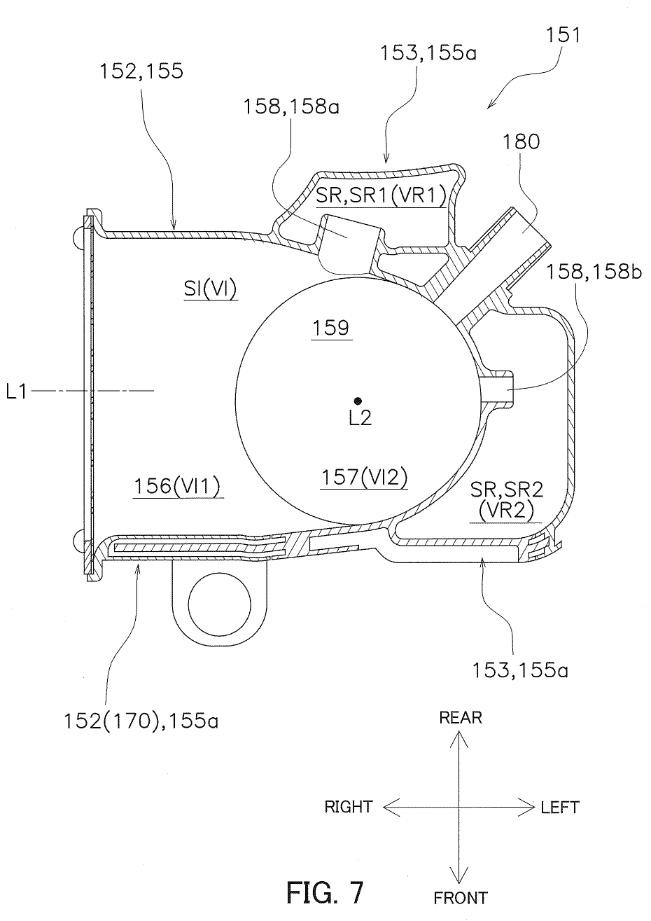

As shown in FIG. 6, at least one connecting hole 158 includes a first connecting hole 158a and a second connecting hole 158b. FIG. 7 is a cross-sectional view of the silencer 151 in a state where the silencer 151 is cut by a line VII in FIG. 6. As shown in FIGS. 6 and 7, the first connecting hole 158a penetrates a wall of the intake passage 152 and connects the internal space SI of the intake passage 152 and the internal space SR of the resonator 153 to each other. In this example embodiment, the first connecting hole 158a connects the internal space SI of the intake passage 152 and a first internal space SR1 of the resonator 153 to each other.

One end of the first connecting hole 158a is connected to the internal space SI of the intake passage 152. For example, the one end of the first connecting hole 158a is connected to the internal space SI of the first passage 156. Specifically, the one end of the first connecting hole 158a is connected to the internal space SI of the first passage 156 at the connection 159 of the first passage 156. The one end of the first connecting hole 158a may be partially connected to the internal space SI of the second passage 157. The other end of the first connecting hole 158a is connected to the first internal space SR1 of the resonator 153.

As shown in FIGS. 6 and 7, the second connecting hole 158b penetrates the wall of the intake passage 152 and connects the internal space SI of the intake passage 152 and the internal space SR of the resonator 153 to each other. In this example embodiment, the second connecting hole 158b connects the internal space SI of the intake passage 152 and a second internal space SR2 (described below) of the resonator 153 to each other.

One end of the second connecting hole 158b is connected to the internal space SI of the intake passage 152. For example, the one end of the second connecting hole 158b is connected to the internal space SI of the first passage 156. Specifically, the one end of the second connecting hole 158b is connected to the internal space SI of the first passage 156 at the connection 159 of the first passage 156. The one end of the second connecting hole 158b may be partially connected to the internal space SI of the second passage 157. The other end of the second connecting hole 158b is connected to the second internal space SR 2 of the resonator 153. In FIGS. 6 and 7, a connecting portion 180 for blow-by gas is connected to the intake passage 152. The connecting portion 180 for the blow-by gas is not an element of the resonator 153 and is not included in configuration of the resonator 153.

The resonator 153 reduces or prevents air intake noise. The phrase “reduces or prevents the air intake noise” and similar phrases include the meanings of “reducing the intake noise overall,” “reducing the frequency of unnecessary noise in the intake noise,” and “attenuating the frequency of sound which is an adjusting target of the intake noise.” As shown in FIGS. 5, 6 and 7, the resonator 153 is provided on the intake passage 152. The resonator 153 is integral with the intake passage 152 by a housing 155 which includes a plurality of members.

Specifically, as shown in FIGS. 6 and 7, the resonator 153 is integral with the intake passage 152 so as to partially protrude from a rear portion of the first passage 156, a left portion of the connection 159 of the first passage 156, and an upper portion of the first passage 156.

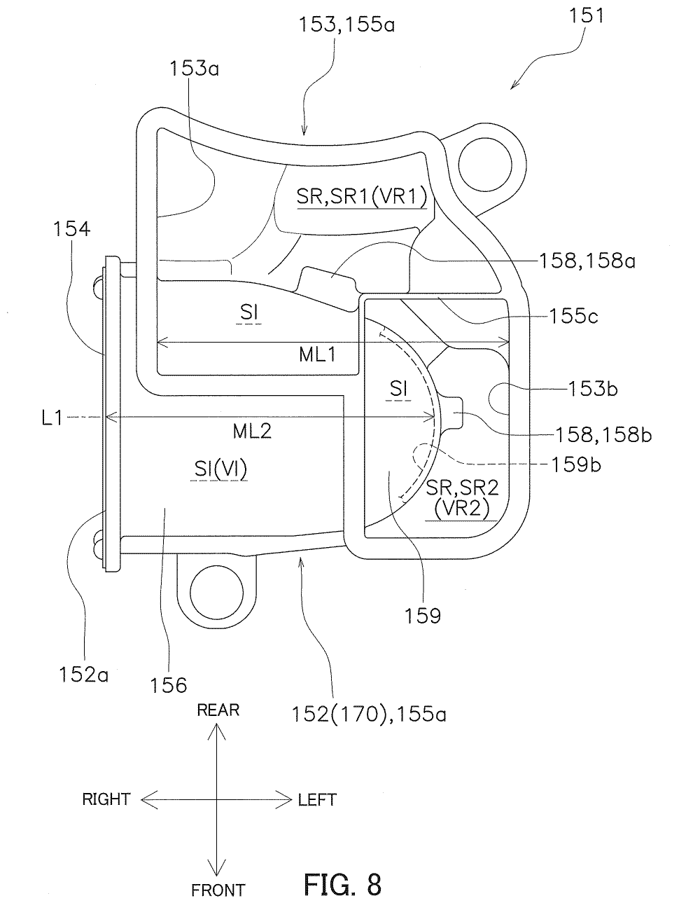

FIG. 8 is a top view of the silencer 151 in a state where the cover portion 155b is rid of the housing 155. As shown in FIGS. 6, 7, and 8, the internal space SR of the resonator 153 is defined by the housing 155, for example, the housing body 155a and the cover portion 155b.

The internal space SR of the resonator 153 is a closed space. The internal space SR of the resonator 153 is integral with the internal space SI of the intake passage 152. Specifically, the internal space SR of the resonator 153 is integral with the internal space SI of the intake passage 152 via the first connecting hole 158a and the second connecting hole 158b.

The resonator 153 is provided on the intake passage 152 so that the internal space SR of the resonator 153 covers at least a portion of the first passage 156 of the intake passage 152. In this example embodiment, the internal space SR of the resonator 153 is provided on the rear portion of the first passage 156, on the left of the first passage 156, and on the upper portion of the first passage 156.

The resonator 153 is provided on the intake passage 152 so that the internal space SR of the resonator 153 covers at least a portion of the connection 159 of the first passage 156. In this example embodiment, the internal space SR of the resonator 153 is provided on a rear portion of the connection 159 of the first passage 156, on a left portion of the connection 159 of the first passage 156, and an upper portion of the connection 159 of the first passage 156.

As shown in FIGS. 7 and 8, at least a portion of the resonator 153 is provided on the side portion of the intake passage 152 so that at least a portion of the internal space SR of the resonator 153 overlaps with the internal space SI of the intake passage 152, in a left-right view in a state where the propulsion unit body 110 is viewed from the left or the right and/or in a front-rear view in a state where the propulsion unit body 110 is viewed from the front or the rear.

In this example embodiment, the portion of the resonator 153 is provided on the side portion of the intake passage 152 so that a portion of the internal space SR of the resonator 153 overlaps with the internal space SI of the intake passage 152 in the left-right view or in the front-rear view.

As shown in FIG. 8, at least a portion of the resonator 153 is provided on an upper portion of the intake passage 152 so that at least a portion of the internal space SR of the resonator 153 overlaps with the internal space SI of the intake passage 152 in the top view of the propulsion unit body 110.

In this example embodiment, the portion of the resonator 153 is provided on the upper portion of the intake passage 152 so that a portion of the internal space SR of the resonator 153 overlaps with the internal space SI of the intake passage 152 in the top view of the propulsion unit body 110.

In this example embodiment, the internal space SR of the resonator 153 is divided into the first internal space SR1 and the second internal space SR2 by a partition wall 155c of a housing body 155a shown in FIG. 8. In other words, the internal space SR of the resonator 153 includes the first internal space SR1 and the second internal space SR2.

As shown in FIG. 7 and FIG. 8, the first internal space SR1 is a closed space. The first internal space SR1 is connected to the internal space SI of the intake passage 152 via the first connecting hole 158a. The first internal space SR1, a space of the first connecting hole 158a, and the internal space SI of the intake passage 152 are integral with each other.

The second internal space SR2 is a closed space which is different from the first internal space SR1. The second internal space SR2 is adjacent to the first internal space SR1 via the partition wall 155c. The second internal space SR2 is connected to the internal space SI of the intake passage 152 via the second connecting hole 158b. The second internal space SR2, a space of the second connecting hole 158b, and the internal space SI of the intake passage 152 are integral with each other.

In this manner, an internal space of the silencer 151 is defined by the first internal space SR1, the space of the first connecting hole 158a, the second internal space SR2, the space of the second connecting hole 158b and the internal space SI of the intake passage 152.

As described above, the internal space SR of the resonator 153 includes the first internal space SR1 and the second internal space SR2. In this case, as shown in FIG. 8, the resonator 153 is provided on the intake passage 152 so that the first internal space SR1 covers at least a portion of the first passage 156 between the intake inlet 152a of the first passage 156 and the connection 159 of the first passage 156.

In this example embodiment, the resonator 153 is provided on the intake passage 152 so that the first internal space SR1 covers the rear and upper portions of the first passage 156 between the intake inlet 152a of the first passage 156 and the connection 159 of the first passage 156.

A portion of the resonator 153 is provided on a rear portion of the intake passage 152 (an example of a side of the intake passage 152) so that a portion of the first internal space SR1 overlaps with the internal space SI of the intake passage 152 in the front-rear view. The portion of the resonator 153 is provided on the upper portion of the intake passage 152 so that a portion of the first internal space SR1 overlaps with the internal space SI of the intake passage 152 in a vertical view in a state where the propulsion unit body 110 is viewed from above or below.

As shown in FIG. 8, the resonator 153 is provided on the intake passage 152 so that the second internal space SR2 covers at least a portion of the first passage 156. For example, the resonator 153 is provided on the intake passage 152 so that the second internal space SR2 covers at least a portion of the connection 159 of the first passage 156.

In this example embodiment, the resonator 153 is provided on the intake passage 152 so that the second internal space SR2 covers the connection 159 of the first passage 156. For example, the resonator 153 is provided on the intake passage 152 so that the second internal space SR2 covers the left portion of the connection 159 of the first passage 156, the rear portion of the connection 159 of the first passage 156 and the upper portion of the connection 159 of the first passage 156.

The portion of the resonator 153 is provided on the connection 159 of the intake passage 152 so that a portion of the second internal space SR2 overlaps with the internal space SI of the intake passage 152 in the left-right view.

The portion of the resonator 153 is provided on the connection 159 of the intake passage 152 so that the portion of the second internal space SR2 overlaps with the internal space SI of the intake passage 152 in the front-rear view. The portion of the resonator 153 is provided on the connection 159 of the intake passage 152 so that the portion of the second internal space SR2 overlaps with the internal space SI of the intake passage 152 in the vertical view.

As shown in FIGS. 6, 7, and 8, the volume VR (=VR1+VR2) of the internal space SR of the resonator 153 is greater than the volume VI of the internal space SI of the intake passage 152. The volume VR of the internal space SR of the resonator 153 is defined by an inner surface of the housing 155 which defines the internal space SR of the resonator 153. The volume VI of the internal space SI of the intake passage 152 is defined by the volume between the intake inlet 152a and the intake outlet 152b in the intake passage 152.

In this example embodiment, the sum (VR=VR1+VR2) of the volume VR1 of the first internal space SR1 of the resonator 153 and the volume VR2 of the second internal space SR2 of the resonator 153 is greater than the sum (VI=VI1+VI2) of the volume VI1 of the internal space SI of the first passage 156 of the intake passage 152 and the volume VI2 of the internal space SI of the second passage 157 of the intake passage 152.

The volume VR1 of the first internal space SR1 of the resonator 153 is defined by the inner surface of the housing 155 which defines the first internal space SR1 of the resonator 153. The volume VR2 of the second internal space SR2 of the resonator 153 is defined by the inner surface of the housing 155 which defines the second internal space SR2 of the resonator 153.

The volume VI1 of the internal space SI of the first passage 156 of the intake passage 152 is defined by the intake inlet 152a, the inner surface of the housing 155 which defines an internal space of the first passage 156 and the connection surface 159a of the connection 159 shown in FIG. 6. The connection surface 159a is a boundary surface between the first passage 156 and the second passage 157. The volume VI2 of the internal space SI of the second passage 157 of the intake passage 152 is defined by the connection surface 159a of the connection 159, the inner surface of the housing 155 which defines an internal space of the second passage 157 and the intake outlet 152b.

The silencer 151 including the above configuration is preferably configured as follows. A first maximum length ML1 is defined as a maximum length between inner surfaces 153a, 153b of the resonator 153 which face each other in a direction in which the first passage 156 extends. A second maximum length ML2 is defined as a maximum length from the intake inlet 152a to the inner surface 159b of the connection 159 in the above direction. The first maximum length ML1 is greater than the second maximum length ML2.

In this example embodiment, the direction in which the first passage 156 extends corresponds to the left-right direction in which the first straight line L1 extends. The first maximum length ML1 between the inner surfaces 153a, 153b of the resonator 153 is the maximum length between the inner surface 153a on the intake inlet 152a side which defines the first internal space SR1 of the resonator 153 and the inner surface 153b on the connection 159 side which defines the second internal space SR2 of the resonator 153.

In this example embodiment, an example is shown in which the internal space SR of the resonator 153 is defined by the first internal space SR1 and the second internal space SR2. The internal space SR of the resonator 153 may be a single internal space SR without using the partition wall 155c.

In this case, the first maximum length ML1 between the inner surfaces of the resonator 153 is the maximum length between the inner surface 153a on the intake inlet 152a side which defines the internal space SR of the resonator 153 and the inner surface 153b on the connection 159 side which defines the internal space SR of the resonator 153.

In the silencer 151 including the above-described configuration, the air, which is drawn from the intake inlet 152a, passes through the intake passage 152 and is supplied to the throttle body 150 through the intake outlet 152b. When the air passes through the intake passage 152, the intake noise generated during intake is reduced or prevented by the resonator 153.

In the above-described watercraft propulsion unit 100, the intake structure 170 is defined by the intake passage 152 and the throttle body 150. Since the intake passage 152 is directly connected to the throttle body 150, it is possible to reduce the size of the intake structure 170 in comparison with the prior art. In addition, in the watercraft propulsion unit 100, since the volume VR of the internal space SR of the resonator 153 is greater than the volume VI of the internal space SI of the intake passage 152, it is possible to reduce or prevent the intake noise. In other words, in the watercraft propulsion unit 100, it is possible to reduce a size of the intake structure 170 and reduce or prevent the intake noise.

In the watercraft propulsion unit 100, the internal space SR of the resonator 153 is a closed space and is integral with the internal space SI of the intake passage 152. In this case, even if the volume VR of the internal space SR of the resonator 153 is greater than the volume VI of the internal space SI of the intake passage 152, it is possible to reduce the size of the intake structure 170.

In the watercraft propulsion unit 100, the resonator 153 is separate from the intake passage 152 and is mounted to the intake passage 152. In this case, the resonator 153 can be easily mounted and detached from the intake passage 152.

In the watercraft propulsion unit 100, the intake passage 152 is disposed between the throttle body 150 and at least a portion of the resonator 153. In this case, the internal space SR of the resonator 153 is configured so that the volume VR of the internal space SR of the resonator 153 is greater than the volume VI of the internal space SI of the intake passage 152.

In the watercraft propulsion unit 100, at least a portion of the intake passage 152 is disposed above the throttle body 150. The intake passage 152 is disposed between the throttle body 150 and the portion of the resonator 153 in the vertical direction. In this case, even if the internal space SR of the resonator 153 is configured so that the volume VR of the internal space SR of the resonator 153 is greater than the volume VI of the internal space SI of the intake passage 152, it is possible to reduce the size of the intake structure 170.

In the watercraft propulsion unit 100, at least a portion of the intake passage 152 is disposed above the throttle body 150. At least a portion of the resonator 153 is provided on the side portion of the intake passage 152 so that at least a portion of the internal space SR of the resonator 153 overlaps with the internal space SI of the intake passage 152 in a view in a state where the watercraft propulsion unit 100 is viewed in at least one of the left-right direction of the watercraft propulsion unit 100 or a front-rear direction of the watercraft propulsion unit 100.

In this case, the internal space SR of the resonator 153 is configured so that the volume VR of the internal space SR of the resonator 153 is greater than the volume VI of the internal space SI of the intake passage 152. In addition, even if the internal space SR of the resonator 153 is such that the volume VR of the internal space SR of the resonator 153 is greater than the volume VI of the internal space SI of the intake passage 152, it is possible to reduce the size of the intake structure 170.

In the watercraft propulsion unit 100, at least a portion of the intake passage 152 is disposed above the throttle body 150. At least a portion of the resonator 153 is provided on the upper portion of the intake passage 152 so that at least a portion of the internal space SR of the resonator 153 overlaps with the internal space SI of the intake passage 152 in the top view in a state where the propulsion device is viewed from above to below.

In this case, the internal space SR of the resonator 153 is configured so that the volume VR of the internal space SR of the resonator 153 is greater than the volume VI of the internal space SI of the intake passage 152. In addition, even if the internal space SR of the resonator 153 is such that the volume VR of the internal space SR of the resonator 153 is greater than the volume VI of the internal space SI of the intake passage 152, it is possible to reduce the size of the intake structure 170.

In the watercraft propulsion unit 100, the intake passage 152 includes the first passage 156 including the intake inlet 152a and the second passage 157 including the intake outlet 152b. The first straight line L1 extends through the center of the intake inlet 152a and extending along the first passage 156, and the second straight line L2 extends through the center of the intake outlet 152b and extending along the second passage 157. The first straight line L1 and the second straight line L2 intersect with each other.

In this case, the air is drawn from the intake inlet 152a of the first passage 156 and moves in the first passage 156 along the first straight line L1. The air then moves in the second passage 157 along the second straight line L2 and is discharged through the intake outlet 152b of the second passage 157. Thus, it is possible to reduce the size of the intake passage.

In the watercraft propulsion unit 100, the intake passage 152 includes the connecting hole 158 which connects the internal space SI of the intake passage 152 and the internal space SR of the resonator 153 to each other. At least a portion of the connecting hole 158 is connected to the internal space SI of the intake passage 152 in the first passage 156. In this case, the intake noise of the air passing in the first passage 156 is reduced or prevented by the resonator 153.

In the watercraft propulsion unit 100, the first passage 156 includes the connection 159 which is provided on an opposite side to the intake inlet 152a and is connected to the second passage 157. At least a portion of the connecting hole 158 is connected to the internal space SI of the intake passage 152 at the connection 159. In this case, the intake noise of the air passing in the connection 159 of the first passage 156 is reduced or prevented by the resonator.

In the watercraft propulsion unit 100, the first passage 156 includes the connection 159 which is provided on an opposite side to the intake inlet 152a and connected to the second passage 157. The resonator 153 is provided on the intake passage 152 so that the internal space SR of the resonator 153 covers at least a portion of the connection 159. In this case, it is possible to reduce the size of the resonator 153.

In the watercraft propulsion unit 100, the first maximum length ML1 is defined as a maximum length between inner surfaces of the resonator 153 which face each other in a direction in which the first passage 156 extends. A second maximum length ML2 is defined as a maximum length from the intake inlet 152a to an inner surface of the connection 159 in the direction. The first maximum length ML1 is greater than the second maximum length ML2. In this case, it is possible to reduce the size of the resonator 153 and reduce or prevent the intake noise.

Although example embodiments of the present invention have been described above, the present invention is not limited to the above example embodiments and various modifications are possible without deviating from the gist of the present invention.

In the silencer 151 of the above example embodiments, an example in which the intake passage 152 and the resonator 153 are integral with the housing 155 has been described. The resonator 153 can be separate from the intake passage 152 so that it can be mounted to and detached from the intake passage 152.

In the above example embodiments, an example in which the silencer 151 is used in the watercraft propulsion unit 100 has been described. The silencer 151 can be applied to a propulsion device other than the watercraft propulsion unit 100.

According to example embodiments of the present invention, it is possible to provide propulsion devices, watercraft propulsion units and watercraft which reduce the size of an intake structure and reduce or prevent intake noise.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A propulsion device comprising:
an engine body;
a throttle body to supply air to the engine body;
an intake passage connected to the throttle body on an upstream side of the throttle body and including an intake inlet to draw in the air and an intake outlet to guide the air to the throttle body; and
a resonator connected to the intake passage to reduce an intake sound of the air; wherein
a volume of an internal space of the resonator is greater than a volume of an internal space of the intake passage between the intake inlet and the intake outlet.

2. The propulsion device according to claim 1, wherein the internal space of the resonator is a closed space integral with the internal space of the intake passage.

3. The propulsion device according to claim 1, wherein the resonator is separate from the intake passage and mounted to the intake passage.

4. The propulsion device according to claim 1, wherein the intake passage is between the throttle body and at least a portion of the resonator.

5. The propulsion device according to claim 4, wherein
at least a portion of the intake passage is above the throttle body; and
the intake passage is between the throttle body and a portion of the resonator in a vertical direction.

6. The propulsion device according to claim 1, wherein
at least a portion of the intake passage is above the throttle body; and
at least a portion of the resonator is located on a side portion of the intake passage so that at least a portion of the internal space of the resonator overlaps with the internal space of the intake passage in a top view in a state where the propulsion device is viewed in at least one of a left-right direction of the propulsion device or a front-rear direction of the propulsion device.

7. The propulsion device according to claim 1, wherein
at least a portion of the intake passage is above the throttle body; and
at least a portion of the resonator is located on an upper portion of the intake passage so that at least a portion of the internal space of the resonator overlaps with the internal space of the intake passage in a top view in a state where the propulsion device is viewed from above to below.

8. The propulsion device according to claim 1, wherein
the intake passage includes a first passage including the intake inlet and a second passage including the intake outlet; and
a first straight line extending through a center of the intake inlet and along the first passage and a second straight line extending through a center of the intake outlet and along the second passage intersect with each other.

9. The propulsion device according to claim 8, wherein
the intake passage includes a connecting hole to connect the internal space of the intake passage and the internal space of the resonator to each other; and
at least a portion of the connecting hole is connected to the internal space of the intake passage in the first passage.

10. The propulsion device according to claim 9, wherein
the first passage includes a connection on an opposite side to the intake inlet and connected to the second passage; and
at least a portion of the connecting hole is connected to the internal space of the intake passage at the connection.

11. The propulsion device according to claim 8, wherein
the first passage includes a connection on an opposite side to the intake inlet and connected to the second passage; and
the resonator is connected to the intake passage so that the internal space of the resonator covers at least a portion of the connection.

12. The propulsion device according to claim 8, wherein
a first maximum length that is a maximum length between inner surfaces of the resonator which face each other in a direction in which the first passage extends is greater than a second maximum length that is a maximum length from the intake inlet to an inner surface of the connection in the direction.

13. A watercraft propulsion unit comprising:
an engine body;
a throttle body to supply air to the engine body;
an intake passage connected to the throttle body on an upstream side of the throttle body and including an intake inlet to draw in the air and an intake outlet to guide the air to the throttle body; and
a resonator connected to the intake passage to reduce an intake sound of the air; wherein
a volume of an internal space of the resonator is greater than a volume of an internal space of the intake passage between the intake inlet and the intake outlet.

14. A watercraft comprising:
a watercraft body; and
the watercraft propulsion unit according to claim 13 mounted to a rear portion of the watercraft body.
